(19) United States
(12) Patent Application Publication
(10) Pub. No.: US 2026/0207008 A1
(43) Pub. Date: Jul. 23, 2026

(54) COFFEE GRINDING MACHINE

(71) Applicant: LA MARZOCCO S.R.L., SCARPERIA E SAN PIERO (FI) (IT)

(72) Inventors: Marco BECCASTRINI, SCARPERIA E SAN PIERO (Fl) (IT); Mario DONNINI, SCARPERIA E SAN PIERO (Fl) (IT); Riccardo GATTI, SCARPERIA E SAN PIERO (Fl) (IT)

(21) Appl. No.: 19/143,777

(22) PCT Filed: Dec. 28, 2023
(86) PCT No.: PCT/IB2023/063307

§ 371 Date: Jun. 26, 2025

(30) Foreign Application Priority Data
Dec. 30, 2022 (IT) 102022000027273

(51) Int. Cl. A47J 42/02; A47J 42/40

(52) U.S. Cl. CPC A47J 42/02; A47J 42/40

(57) ABSTRACT

A coffee grinding machine is described, said machine comprising a machine body, a grinding chamber, a first burr and a second burr mutually movable with respect to each other so as to grind coffee beans, and a discharge duct for receiving ground coffee exiting the grinding chamber and for conveying the ground coffee towards a container, wherein the discharge duct is connected to the machine body by means of a magnetic attraction force and wherein the total magnetic attraction force is greater than the weight of the discharge duct. For example, the total magnetic attraction force is equal to the weight of the discharge duct plus at least 50 grams, for example 50-150 grams.

### BACKGROUND

The present invention relates to a machine for grinding coffee beans. The machine for grinding coffee beans may be a separate machine or may be incorporated in an at least partly automatic machine for the production of coffee-based beverages. Such a machine is also known simply as a “coffee grinding machine”, “coffee grinder” or “mill”.

### PRIOR ART

Two categories of coffee grinding machine are known: one category uses volumetric dosing and has a storage container, while the other category is of the “on-demand” type, i.e. with instantaneous dosing, but without storage of the ground coffee. The present invention relates to both categories of machine, but preferably to coffee grinding machines of the on-demand type, with instantaneous dosing, but without storage of the ground coffee.

Coffee grinding machines comprising a body housing two superimposed grinding burrs, one of which is rotationally operated by an electric motor, and the other one of which is movable axially with respect to the first one upon operation of a threaded ring engaging inside the burr housing body, are known.

Once the coffee has been ground, it is conveyed from the grinding chamber to a discharge duct, typically through a tunnel.

Typically the discharge duct has a converging form for suitably directing the ground coffee towards a container. Generally, the container is a filter inserted inside a filter holder. As is known, the filter holder with the filter filled with ground coffee is reversibly engaged with a dispensing group of an espresso coffee machine for the preparation of an espresso coffee.

U.S. Pat. No. 9,066,629 B1, US 2018/199750 A1 and US 2021/113020 A1 describe coffee grinding machines.

### SUMMARY OF THE INVENTION

The Applicant has noticed that coffee powder tends to accumulate on the inner walls (as well as in other zones) of a discharge duct of a coffee grinding machine. Obviously, the coffee powder which accumulates on the walls of the discharge duct must be removed for various reasons. The first reason is that the coffee which is deposited on the walls deteriorates and may result in the formation of mould and bacteria which are transmitted to the coffee powder which is used for preparation of an espresso coffee. Because of said mould and bacteria, the quality of the prepared beverage deteriorates significantly, from both an organoleptic and a sanitary point of view.

Coffee grinding machine manufacturers advise removing and carefully cleaning the discharge duct regularly in order to avoid the aforementioned drawbacks. However, unfortunately, some coffee grinding machine users neglect the maintenance and cleaning of the discharge duct and take action only when the situation has become noticeably worse. For example, it may happen that some users remove the discharge duct only when there are problems discharging the ground coffee powder or the amount of ground coffee powder discharged is significantly less than that desired. Or the users may perceive unpleasant smells from the coffee grinding machine and the ground coffee.

A further problem may also be that of blockage of the discharge duct. In fact, if the discharge duct should be obstructed in any way, the coffee, since it is unable to be discharged, could return back upwards towards the burrs and block them. The coffee thus compressed is extremely difficult to remove and may require disassembly of some parts in order to carry out cleaning.

The Applicant has defined the aim of providing a solution to the aforementioned problem and providing a system for engagement of the discharge duct which obliges, or at least encourages, a user to remove the discharge duct frequently in order to prevent the discharge duct from becoming blocked, even only partially. Advantageously, the engagement system according to the present invention also achieves the aim of allowing maintenance and cleaning.

The Applicant has observed that the accumulation of coffee powder on the inner wall of the discharge duct results in a not insignificant increase in the weight of the discharge duct.

According to the present invention, a coffee grinding machine comprising a system configured to disengage the discharge duct and prevent operation of the machine when a preset weight of the discharge duct is exceeded is provided.

In particular, a magnetic system for connecting together the discharge duct and the body of the coffee grinding machine is provided, and the magnetic attraction force is set so as to keep the discharge duct connected to the machine body up to a certain weight which takes into account the dry weight of the discharge duct and the weight of the discharge duct which has a predetermined amount (considered to be acceptable and not excessive) of coffee powder on the inner wall. Should an amount of coffee powder considered to be excessive is deposited on the inner surface of the discharge duct, the magnetic attraction force would no longer be sufficient to keep the discharge duct in position, firmly engaged. Separation of the discharge duct interrupts an electric circuit or, in any other way, interrupts the electric power supply to the machine and forces the user to disassemble the discharge duct in order to remove the powder which has accumulated on the inner wall or on other parts of the discharge duct.

A safety device is preferably provided in order to prevent the discharge duct from falling and becoming completely separated from the rest of the machine.

According to a first aspect, the present invention provides a coffee grinding machine comprising a machine body, a grinding chamber, a first burr and a second burr mutually movable with respect to each other so as to grind coffee beans, and a discharge duct for receiving ground coffee exiting the grinding chamber and for conveying the ground coffee towards a container, wherein the discharge duct is connected to the machine body by means of a total magnetic attraction force and wherein the total magnetic attraction force is greater than the mass (weight) of the discharge duct.

According to embodiments, the total magnetic attraction force is greater than the mass (weight) of the discharge duct by a predefined amount corresponding to the amount of coffee power deposited on parts of the discharge duct after a predefined number of coffee bean grinding cycles.

According to embodiments, the total magnetic attraction force is substantially equal to the mass (weight) of the discharge duct after a predetermined number of hours or working days.

According to embodiments, the discharge duct comprises an engagement ring.

According to embodiments, the engagement ring comprises two radially projecting lugs and
each of the radially projecting lugs comprises a magnet and the machine body comprises a ferromagnetic material or a ferromagnetic plate fixed to the machine body or
each of the radially projecting lugs comprises a ferromagnetic material and the machine body comprises at least one magnet at each lug.

According to embodiments, the coffee grinding machine according to the claim also comprises a mechanical safety device for preventing the discharge duct from falling owing to an excessive accumulation of coffee powder or accidental causes.

According to embodiments, each of the projecting lugs comprises a through-hole and the machine body comprises a threaded hole at each of the two lugs, wherein the mechanical safety device comprises a screw screwed into each threaded hole so that a portion of the shank of the screw projects with respect to the lug, the shank portion constituting the falling path of the discharge duct when the discharge duct is disengaged from the machine body.

According to embodiments, the coffee grinding machine also comprises a microswitch for interrupting the power supply to the coffee grinding machine when the discharge duct is not engaged.

According to embodiments, the discharge duct comprises a chute and the chute comprises a tongue, wherein the tongue is configured to keep the microswitch pressed in the configuration where the discharge duct is engaged with the machine body by means of the magnetic force.

According to embodiments, the total magnetic attraction force is equal to the weight of the discharge duct plus at least 50 grams. In other words, the total magnetic attraction force is at least 50 grams greater than the weight of the clean discharge duct (without coffee deposits).

According to embodiments, the total magnetic attraction force is greater than the weight of the clean discharge duct (without coffee deposits) by an amount ranging between 50 grams and 200 grams, for example 50-100 grams, or 50-150 grams.

According to embodiments, the total magnetic attraction force is equal to the weight of the discharge duct plus at least 100 grams. In other words, the total magnetic attraction force is at least 100 grams greater than the weight of the clean discharge duct (without coffee deposits). According to embodiments, the total magnetic attraction force is greater than the weight of the clean discharge duct (without coffee deposits) by an amount ranging between 100 grams and 200 grams, for example 100-180 grams or 120-160 grams.

### BRIEF DESCRIPTION OF THE FIGURES

The present invention will become clearer from the following description, provided by way of a non-limiting example, to be read with reference to the accompanying drawings, in which:

FIG. 1.1 shows an example of a coffee grinding machine according to the present invention;

FIG. 1.2 shows a longitudinally sectioned view of the machine according to FIG. 1.1;

FIG. 2.1 and 2.2 are views of the coffee grinding machine with the discharge duct or output duct shown in exploded form;

FIG. 3.1-3.5 show the coffee grinding machine according to FIG. 1 with the discharge duct engaged, in the grinding configuration;

FIG. 4.1-4.4 show the coffee grinding machine according to FIG. 1 with the discharge duct disengaged, in the configuration where grinding cannot occur.

### DETAILED DESCRIPTION

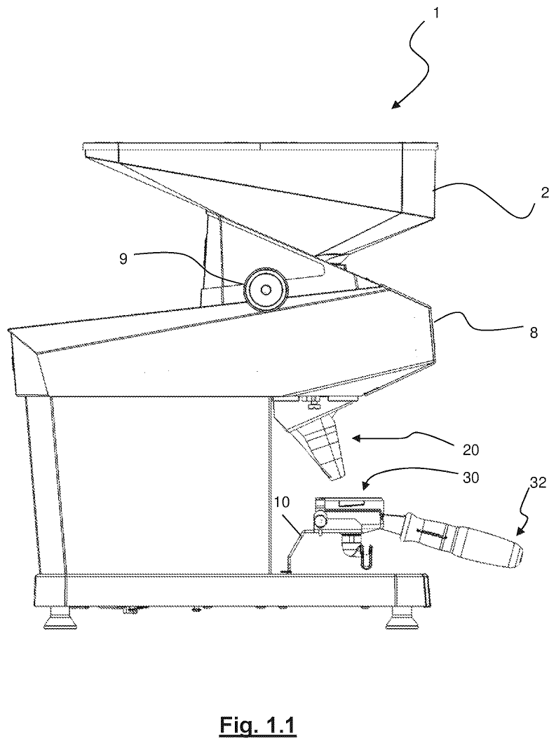

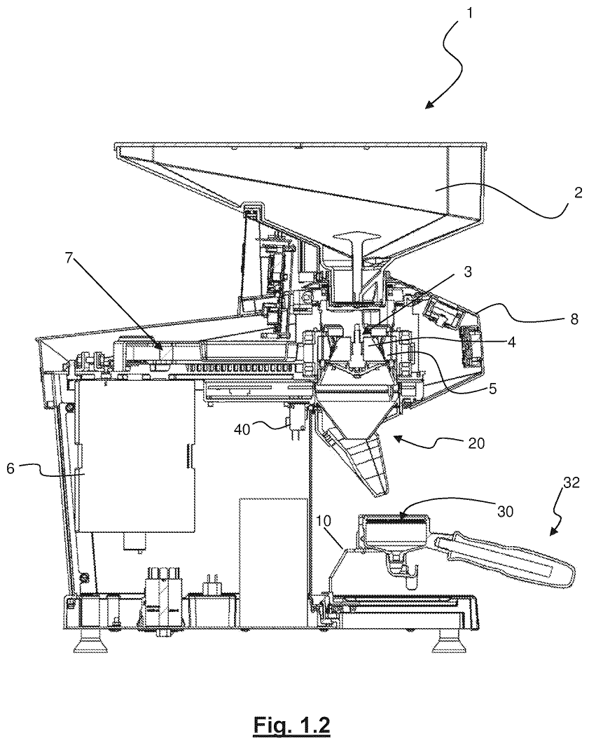

FIG. 1.1 shows, purely by way of example, a coffee grinding machine 1 according to the present invention. FIG. 1.2 is a longitudinally sectioned view of the machine shown in FIG. 1.1, which shows some of the main components. Obviously, a machine according to the present invention may assume any form, also entirely different from that shown in FIG. 1.1 and 1.2. Since the present invention concerns only some components of the machine, other components not essential for understanding of the invention will not be described and/or illustrated.

The machine 1 according to the present invention comprises a hopper 2 for containing a quantity of coffee beans to be ground, a grinding chamber 3 with grinding burrs 4, 5 for grinding the coffee beans received from the grinding chamber, and a discharge duct 20 for conveying the ground coffee powder towards a collection container. FIG. 1.2 shows also a motor 6 with a transmission belt for rotating one of the two burrs 4, 5 with respect to the other one.

Typically, the collection container is a filter 30 of a filter holder 32 for an espresso coffee machine. The coffee grinding machine 1 may comprise a device 9 for modifying the mutual distance between the burrs 4, 5 and therefore adjusting the fineness of the coffee powder exiting the grinding chamber.

Advantageously, the coffee grinding machine 1 may comprise a machine body 8 which houses the various components. The machine body 8 may be at least partially made of metal.

The coffee grinding machine 1 may comprise a support 10 for supporting the filter holder 32 in the correct position, so that the ground coffee is directed towards the filter 30 supported by the filter holder 32.

The discharge duct 20 has preferably a converging form for conveying the ground coffee from a greater cross-section, substantially corresponding to the cross-section of the grinding chamber, to a smaller cross-section compatible with the diameter of the filter 30.

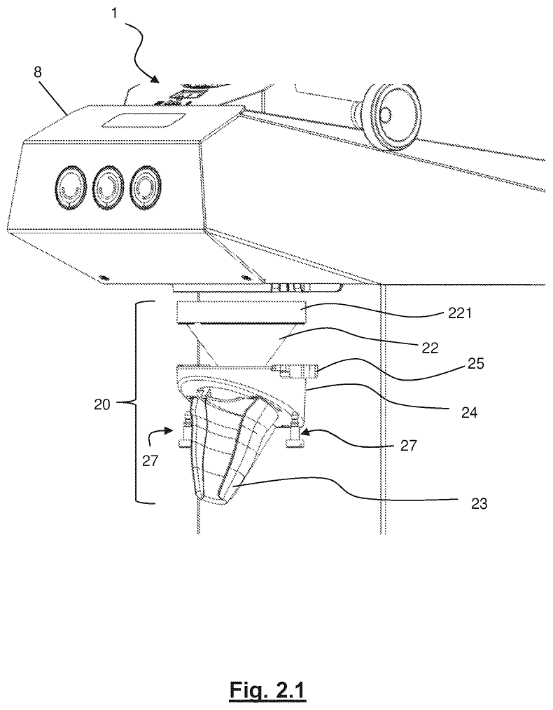

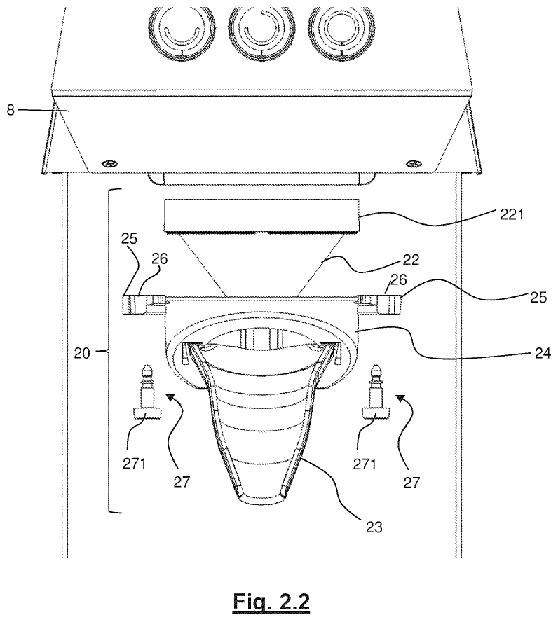

As shown in FIG. 2.1 and 2.2, the discharge duct 20 according to the present invention comprises an internal cone 22 which suitably conveys the ground coffee powder exiting the grinding chamber, a chute 23 and an engagement ring 24 for removably fixing the chute 23 to the main body 8.

The internal cone 22 is substantially funnel-shaped. According to embodiments, the internal cone 22 has a projecting edge 221 at the larger-diameter opening.

The internal cone 22 may be made of metal, but preferably is made of a thermoplastic material.

The chute 123 has the function of receiving the ground coffee from the internal cone 22 and directing it towards the receiving container 30. Advantageously, it may have a portion of the surface which is open. In other words, it is not a closed tube (or cone). It may be made of metal or any thermoplastic material.

The chute 23 is connected integrally or detachably to the engagement ring 24. Internally, the engagement ring 24 is shaped so as to substantially complement the edge 221 of the internal cone 22. In other words, when the engagement ring 24 is connected to the machine body 8, it supports the internal cone 22 and the chute 23.

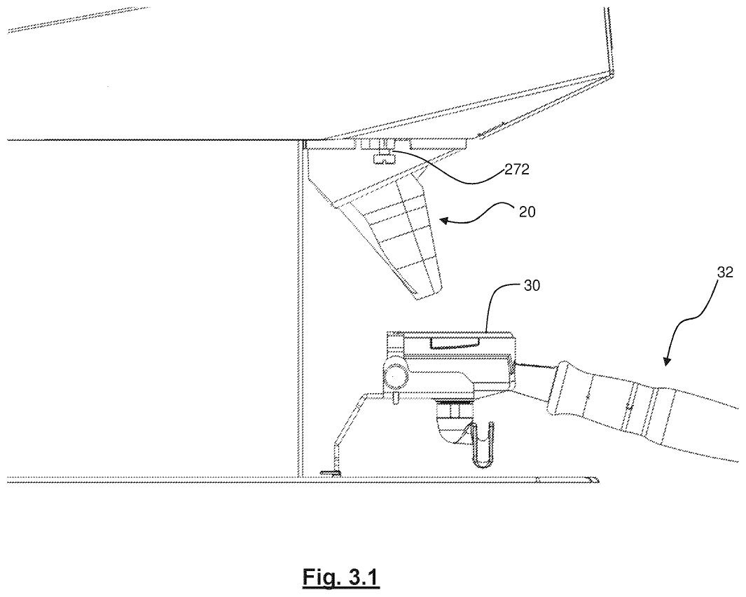

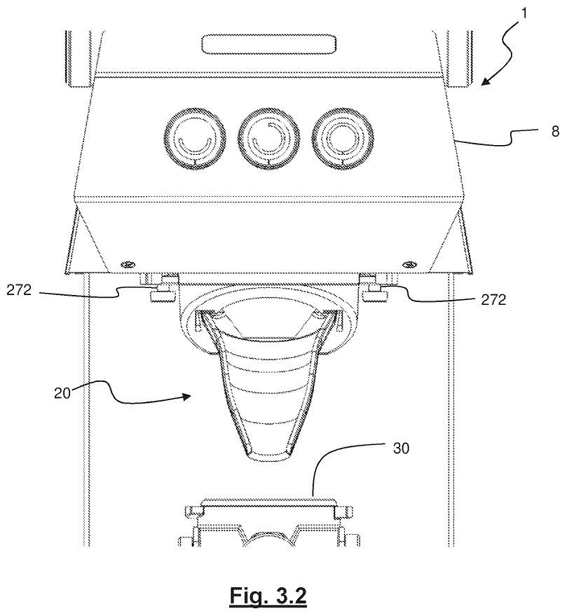

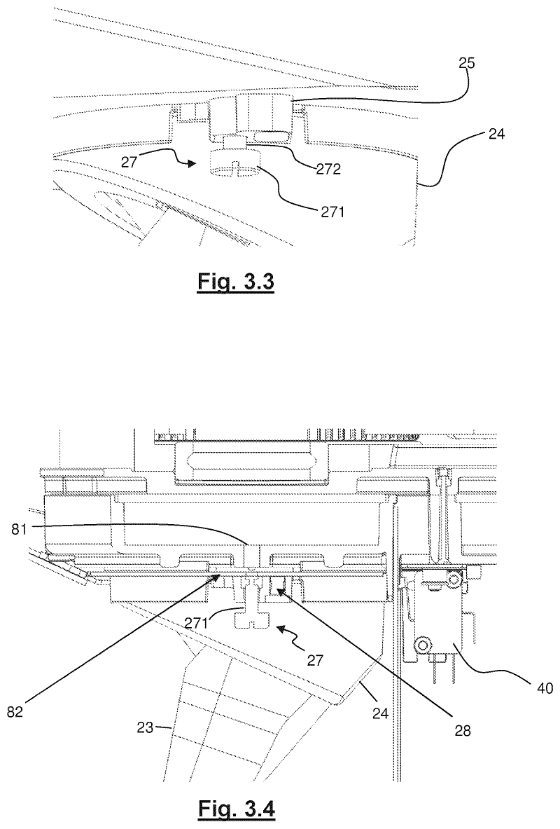

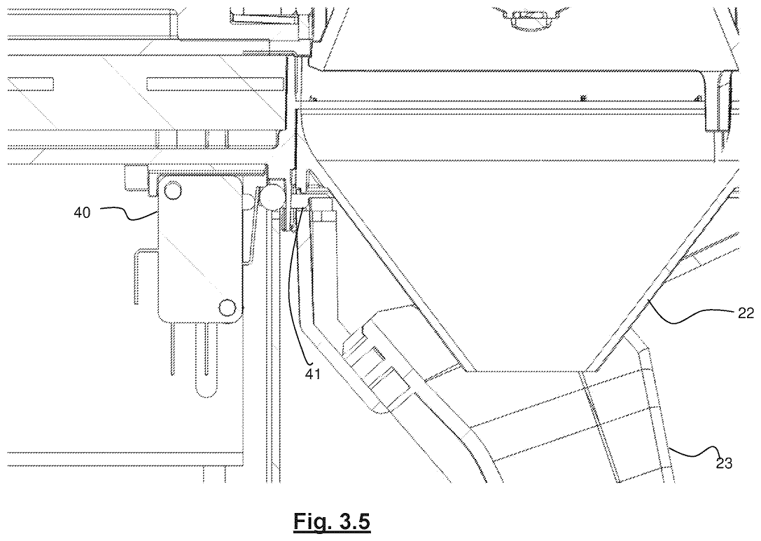

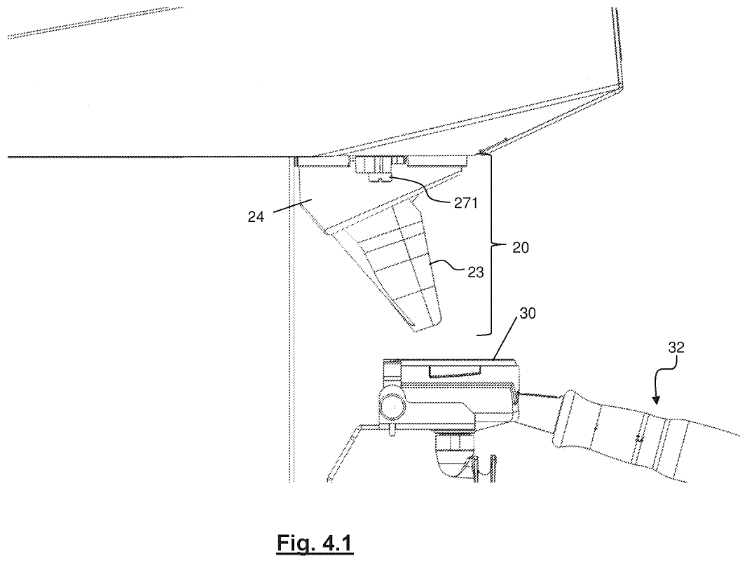

The engagement ring 24 is connected detachably to the machine body 8. According to the invention, the engagement ring 24 is connected by means of a magnetic force. For example, the engagement ring 24 comprises at least one magnet 28 and the body 8 of the coffee grinding machine 1 where the engagement ring 24 is connected comprises at least one ferromagnetic material 82, for example a ferromagnetic plate 82, shown in FIG. 3.4. In other embodiments, the engagement ring 24 comprises at least one ferromagnetic material (or is substantially formed by a ferromagnetic material) and the body 8 of the coffee grinding machine 1 where the engagement ring 24 is connected comprises one or more magnets, for example a magnetic plate.

Alternatives to the aforementioned solution are obviously possible. For example, said engagement system, which is at present magnetic, could also be obtained by means of mechanical type fixing elements, i.e. lateral spring or snap-fitting pushers.

The magnet 28 may be a single magnet or a plurality of magnets 28.

According to embodiments, the magnets 28 are in the form of small cylinders and, preferably, are arranged angularly equally spaced.

In one embodiment, the engagement ring 24 comprises one or more lugs 25 projecting radially outwards. For example, two radially projecting lugs 25 may be provided. Each projecting lug 25 comprises a magnet 28, configured to generate a magnetic attraction force with the ferromagnetic plate 82 or any corresponding ferromagnetic part of the body 8 of the machine 1.

According to the present invention, the total magnetic attraction force between the engagement ring 24 and the machine body 8 is the sum of the magnetic force of the single magnets.

Typically, during use of a coffee grinding machine, the coffee powder is deposited inside the discharge duct 20, for example on the walls of the internal cone 22 and/or on the surface of the chute 23. If the discharge duct 20 is not cleaned regularly, the coffee powder forms layers and the weight of the coffee powder deposited inside the discharge duct may be as much as 100-120 grams or more. Obviously, the amount of coffee powder which may be deposited inside the discharge duct varies greatly and depends, for example, on how compressed the coffee is and the type of particle size, as well as on the ambient conditions (in particular the humidity).

According to the present invention, the total magnetic attraction force is calculated so as to be greater than the weight alone of the discharge duct. In particular, the total magnetic attraction force is substantially equal to the sum of the weight of the discharge duct and the weight of a tolerated amount of ground coffee which is deposited, i.e.

$$TMF = MDC + MWP + THR$$

wherein:

TMF is the total magnetic force, defined by the sum of the magnetic force of the single magnets;

MDC is the weight of the clean discharge duct, without deposited coffee powder; and

MWP is the tolerated weight of the coffee powder which is lost because it is deposited on the walls (and/or in other parts) of the discharge duct 20. The tolerated weight of the coffee powder corresponds to the maximum amount of coffee powder beyond which the discharge duct 20 should be cleaned and the coffee powder removed.

THR is a term which takes into account the thrusting force exerted by the coffee powder output from the grinding chamber. The coffee powder, in fact, when it accumulates, at a certain point comes into contact with the moving parts and is pushed by them. Moreover, in the event of blockage, the particles being output encounter the stationary particles and, being stopped, start to increase in density, pushing in the various directions. This force, although it cannot be precisely quantified, represents a significant part of the force which is required to cause disengagement of the discharge duct. This component increases with an increase in the amount of accumulated coffee. With a small amount of accumulated coffee, this component is irrelevant.

The tolerated weight of the coffee power may be decided by the manufacturer based on the experience and the specific form of the discharge duct. In fact, the form of the discharge duct influences the amount of coffee powder which does not reach the filter, but remains on the walls of the discharge duct or in any corner thereof.

For example, a coffee grinding machine manufacturer may detect that, during normal daily use (considering the number of doses ground at atmospheric pressure and at a reference ambient temperature, with predetermined humidity conditions of the air), the amount of coffee powder which tends to be deposited on the discharge duct ranges between x and y grams. In the same ambient and operating conditions, the amount of coffee powder which is deposited on the discharge duct in two days may be estimated as being twice the daily amount. As the number of days increases, the component due to the thrusting force becomes more significant.

If the manufacturer wishes to encourage the barista to remove the accumulated coffee, in order to prevent blockages and keep the discharge duct clean every day, the total magnetic force TMF will be determined so that it is equal to the weight of the discharge duct MDC plus the weight x or, more prudently, the weight y, where necessary multiplied by a safety factor. In this way, the barista may more easily terminate a typical working day.

In the same way, if the manufacturer wishes to encourage the barista to clean the discharge duct every week the total magnetic force TMF will be determined so that it is equal to the weight of the discharge duct MDC plus the weight x or, more prudently, the weight y, multiplied by the number of working days, for example 5, 6 or 7. Advantageously, a safety factor may be envisaged. In this way, the barista may more easily terminate a typical working week. The safety factor may be, for example, a 10% increase of the tolerated weight MWP.

Alternatively, the manufacturer could aim to prevent blockage and could therefore calibrate the total magnetic force also with a discharge duct on which there is an accumulation of coffee powder in an amount ranging between about 50 g and 200 g or between about 100 g and 160 g, or between about 110 g and about 150 g, or between about 120 g and 140 g, or within any other sub-range.

By setting the total magnetic force in this way, if the barista does not perform cleaning of the discharge duct after the given time period, the total magnetic force is no longer able to retain the discharge duct 20 on the machine body 8. In other words, if the weight of the ground coffee deposited in the discharge duct exceeds the tolerated weight, the weight of the soiled discharge duct is too great and the magnets are unable to fulfil their function of keeping the duct stably fixed to the machine body 8.

For example, if the total magnetic force TMF is equal to MDC+y grams because the manufacturer recommends daily cleaning, a further use of the machine without cleaning the discharge duct at the end of the day could (presumably within a short time) result in disengagement of the discharge duct 20 and the impossibility of using the machine with the soiled discharge duct.

By way of example, x may be about 2 g, 3 g or 4 g. By way of example, y may be about 4 g, 5 g or 6 g.

In general blockage may occur suddenly, owing to poor operation of the machine or incorrect use by the user, for example, when a user strikes the outlet of the discharge cone with the filter holder in an improper manner. Otherwise, it may occur, during normal use, after a few hundreds of kilograms of coffee, for example 300-500 kg, have been ground, depending on the how much coffee tends to be deposited on the surfaces. This corresponds to at least 1 or 2 months of work in an extremely busy bar.

According to embodiments, the total magnetic force is greater than the weight of the discharge duct by about 5%.

According to embodiments, the total magnetic force is greater than the weight of the discharge duct by about 10%.

According to embodiments, the total magnetic force is greater than the weight of the discharge duct by about 15%.

According to embodiments, the total magnetic force is between about 10% and 30% of the weight of the discharge duct.

According to one embodiment of the present invention, a first safety device is provided for preventing the discharge duct 20 from falling as a result of accidents or when the weight of the soiled discharge duct is greater than the total magnetic force. The first safety device is of the mechanical type and defines a landing position for the disengaged discharge duct. The landing position may also be at a small distance from the position in which the discharge duct is engaged.

According to one embodiment, a through-hole 26 for a screw 27 is provided in each lug 25 projecting radially from the engagement ring 24. A threaded hole 81 for the screw 27 is provided on the machine body 8 to which the engagement ring 24 is connected (for each through-hole 26 in the lug). The shank of each screw 27 has a greater length than the sum of the thickness of the lug 25 and the depth of the threaded hole. In this way, when also screwing completely the screw 27 inside the hole, the head 271 of the screw 27 will remain spaced from the lug 25. If the discharge duct 20 becomes detached, it may only fall over a distance 272 which corresponds to the section of the shank of the screw 27 projecting downwards with respect to the lug 25 when the discharge duct 20 is connected to the machine body 8.

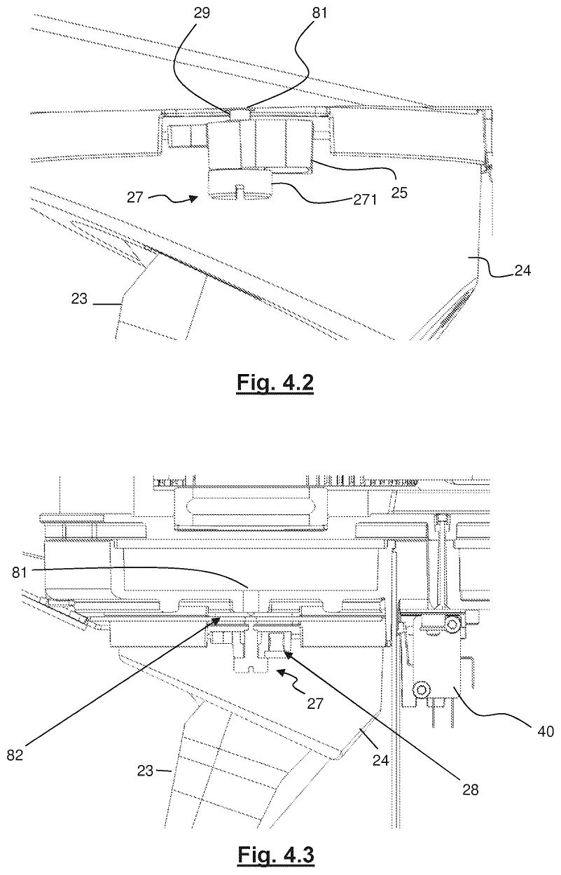

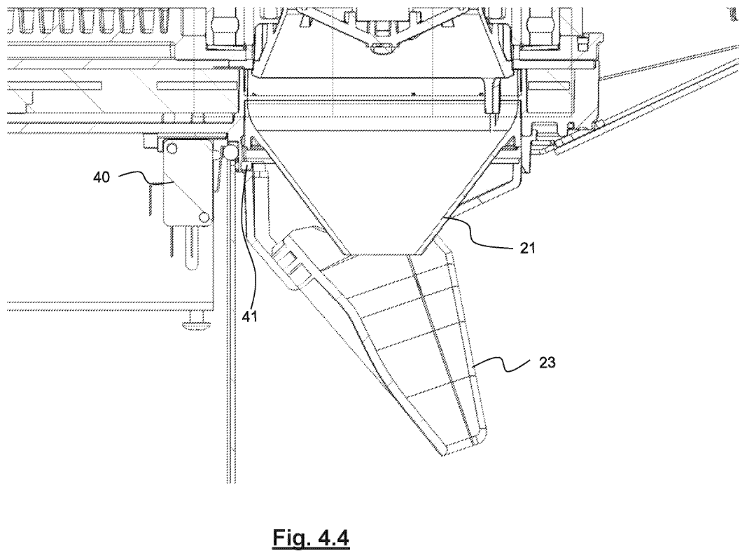

FIG. 3.1, 3.2, 3.3 and 3.4 show the safety screws 27 and the section of the shank 272 which corresponds to the maximum falling distance should the discharge duct 20 become disengaged. FIG. 4.1, 4.2 and 4.3 show the discharge duct 20 disengaged, It is clear how it has “landed” on the heads 271 of the screws 27 and rests on them. The discharge duct 20 has fallen over a distance (again indicated by 272) limited by the section of the screw visible in FIG. 3.1, 3.2, 3.3 and 3.4 The falling path may be one millimetre or in any case a few millimetres, advantageously less than 10 mm, for example about 5 mm.

According to embodiments of the invention, the coffee grinding machine also comprises a microswitch 40 for interrupting the power supply to the motor which causes the rotation of (at least) one burr when the discharge duct is in the disengaged configuration. FIG. 3.5 shows the microswitch 40 in the closed circuit configuration, in which the motor 6 receives the power supply and may rotate at least one of the burrs 3 and 4. In FIG. 4.4 instead, the microswitch 40 is shown in the open circuit configuration, corresponding to the configuration in which the discharge duct 20 is no longer supported by the magnetic force.

According to one embodiment, an electrically conductive tongue 41 may be provided for closing the microswitch 40, being connected to the chute 23 of the discharge duct 20. Alternatively, a metal-contact switch of the Reed sensor type may be used.

1. A coffee grinding machine comprising a machine body, a grinding chamber, a first burr and a second burr mutually movable with respect to each other so as to grind beans of coffee, and a discharge duct for receiving ground coffee exiting the grinding chamber and for conveying the ground coffee towards a container, wherein the discharge duct is connected to the machine body by means of a total magnetic attraction force and wherein the total magnetic attraction force is greater than the weight of the discharge duct.

2. The coffee grinding machine of claim 1, wherein the total magnetic attraction force is greater than the weight of the discharge duct by a predefined amount corresponding to the amount of coffee powder deposited on parts of the discharge duct after a predefined number of coffee bean grinding cycles.

3. The coffee grinding machine of claim 1, wherein the total magnetic attraction force is substantially equal to the weight of the discharge duct after a predetermined number of working hours or working days.

4. The coffee grinding machine according to claim 1, wherein the discharge duct comprises an engagement ring.

5. The coffee grinding machine of claim 4, wherein the engagement ring comprises two radially projecting lugs and wherein
each of the radially projecting lugs comprises a magnet and the machine body comprises a ferromagnetic material or a ferromagnetic plate fixed to the machine body or
each of the radially projecting lugs comprises a ferromagnetic material and the machine body comprises at least one magnet at each ear.

6. The coffee grinding machine of claim 4, further comprising a mechanical safety device for preventing the discharge duct from falling owing to excessive accumulation of coffee powder or accidental causes.

7. The coffee grinding machine of claim 6, wherein each of the projecting ears comprises a through-hole and the machine body comprises a threaded hole at each of the two lugs, wherein the mechanical safety device comprises a screw screwed into each threaded hole so that a portion of the shank of the screw protrudes with respect to the lug, the portion of the shank constituting the falling path of the discharge duct when the discharge duct is disengaged from the machine body.

8. The coffee grinding machine according to claim 1, further comprising a microswitch for interrupting the power supply to the coffee grinding machine when the discharge duct is not engaged.

9. The coffee grinding machine of claim 8, wherein the discharge duct comprises a chute and the chute comprises a tongue wherein the tongue is configured to keep the microswitch pressed in the configuration where the discharge duct is engaged with the machine body by means of the total magnetic force.

10. The coffee grinding machine according to claim 1, wherein the total magnetic attraction force is equal to the weight of the discharge duct plus at least 50 grams.

11. The coffee grinding machine according to claim 1, wherein the total magnetic attraction force is equal to the weight of the discharge duct plus at least 50-200 grams or 50-150 grams.

12. The coffee grinding machine of claim 10, wherein the total magnetic attraction force is equal to the weight of the discharge duct plus at least 100 grams.

13. The coffee grinding machine according to claim 1, wherein the total magnetic attraction force is equal to the weight of the discharge duct plus 100-200 grams, for example 100-180 grams or 120-160 grams.
